(19) United States
(12) Patent Application Publication
(10) Pub. No.: US 2021/0088656 A1
(43) Pub. Date: Mar. 25, 2021

(54) FISH FINDER

(71) Applicant: YAMAHA HATSUDOKI KABUSHIKI KAISHA, Iwata-shi (JP)

(72) Inventor: Kohei TERADA, Shizuoka (JP)

(21) Appl. No.: 17/014,157

(22) Filed: Sep. 8, 2020

(30) Foreign Application Priority Data
Sep. 25, 2019 (JP) 2019-174636

(51) Int. Cl. G01S 15/96; A01K 97/00; G06K 9/00

(52) U.S. Cl. CPC G01S 15/96; G06K 9/00624; G06K 9/00362; A01K 97/00

(57) ABSTRACT

A fish finder includes an image recognition unit to perform an image recognition process on image data outputted by a camera to recognize a characteristic image implying presence of a fish shoal, and a detection result output unit to process the result of the recognition by the image recognition unit to output a detection result. The characteristic image preferably includes at least one of an image containing a fish feeding frenzy, an image containing a tide line, an image of fish flying above the water surface, and an image of a bird.

### CROSS REFERENCE TO RELATED APPLICATIONS

This application claims the benefit of priority to Japanese Patent Application No. 2019-174636 filed on Sep. 25, 2019. The entire contents of this application are hereby incorporated herein by reference.

### BACKGROUND OF THE INVENTION

### 1. Field of the Invention

The present invention relates to a fish finder.

### 2. Description of the Related Art

Fish finders to be mounted on marine vessels are arranged to generate and transmit ultrasonic waves into water under the marine vessel, detect reflection of the ultrasonic waves, and display an underwater state (e.g., fish shoals and water depths) on a display device.

On the other hand, experienced fishermen guess the positions of fish shoals based on a variety of phenomena visually observable from the water surface. Typical examples of such phenomena include so-called bird feeding frenzy, so-called fish feeding frenzy, and a tide line. The term “bird feeding frenzy” means a phenomenon in which birds densely flock around a shoal of small fish chased up to the water surface by larger fish. The term “fish feeding frenzy” means a phenomenon in which it looks as if the water surface is raised by water splashing formed by a shoal of small fish chased up to the water surface by larger fish. The term “tide line” means a visible boundary region appearing in the water surface due to a boundary of ocean currents or the like. In the boundary region, weeds and floating articles are accumulated, so that small fish gather and, hence, large fish eating the small fish gather around the boundary region. The phenomena visually observable from the water surface are known as indirect evidence implying the presence of shoals of fish. The experienced fishermen empirically know these phenomena, and efficiently find good fishing spots.

### SUMMARY OF THE INVENTION

The inventor of preferred embodiments of the present invention described and claimed in the present application conducted an extensive study and research regarding fish finders, such as the one described above, and in doing so, discovered and first recognized new unique challenges and previously unrecognized possibilities for improvements as described in greater detail below.

Experiences and skills are required for finding a fish shoal based on the phenomena visually observable from the water surface and, therefore, it is difficult for inexperienced ordinary people to achieve this.

In order to overcome the previously unrecognized and unsolved challenges described above, preferred embodiments of the present invention provide fish finders that each make it easier to find a fish shoal based on the phenomena visually observable from the water surface.

According to a preferred embodiment of the present invention, a fish finder includes an image recognition unit that performs an image recognition process on image data outputted by a camera to recognize a characteristic image implying the presence of a fish shoal; and a detection result output unit that processes the result of the recognition by the image recognition unit and output a detection result.

With the above structural arrangement, an image of a water surface is photographed by the camera, and the image recognition process is performed on the data of the image outputted by the camera to recognize the characteristic image implying the presence of the fish shoal. Then, the detection result is outputted based on the characteristic image. Thus, the user of the fish finder is able to easily find the fish shoal based on the phenomena observable on the water surface irrespective of the experiences of the user.

In a preferred embodiment of the present invention, the characteristic image includes at least one of an image containing a fish feeding frenzy, an image containing a tide line, an image of fish flying above the water surface, and an image of a bird. With the above structural arrangement, even an inexperienced user is able to easily find the fish shoal with reference to any of the fish feeding frenzy, the tide line, the fish flying above the water surface, and the bird as a clue.

In a preferred embodiment of the present invention, the characteristic image includes an image of fish swimming in the water. With the above structural arrangement, even an inexperienced user is able to easily find the fish shoal with reference to the fish swimming in the water as a clue.

In a preferred embodiment of the present invention, the characteristic image includes an image of birds, and the image recognition unit outputs at least one of the kind of the birds, the number of the birds, and the behavior of the birds as the recognition result based on the image of the birds. With the above structural arrangement, even an inexperienced user is able to easily find the fish shoal with reference to the kind, the number, and the behavior of the birds as a clue.

In a preferred embodiment of the present invention, the behavior of the birds includes at least one of a behavior of the birds plunging into the water surface and a behavior of the birds looking into the water. With the above structural arrangement, even an inexperienced user is able to easily find the fish shoal with reference to the behavior of the birds plunging into water surface or the behavior of the birds looking into the water as a clue.

In a preferred embodiment of the present invention, the detection result output unit outputs the position of the characteristic image in the image photographed by the camera as the detection result. With the above structural arrangement, the position of the characteristic image implying the presence of the fish shoal is outputted as the detection result and, therefore, even an inexperienced user is able to easily find the fish shoal.

In a preferred embodiment of the present invention, the detection result output unit includes a fish shoal position prediction unit that processes the result of the recognition by the image recognition unit to compute a predicted fish shoal position, and the detection result output unit outputs the predicted fish shoal position computed by the fish shoal position prediction unit as the detection result. With the above structural arrangement, the predicted fish shoal position is provided so that even an inexperienced user is able to easily find the fish shoal.

In a preferred embodiment of the present invention, the detection result output unit includes a behavior prediction unit that processes the result of the recognition by the image recognition unit to compute a predicted fish shoal behavior, and the detection result output unit outputs the predicted fish shoal behavior computed by the behavior prediction unit as the detection result. With the above structural arrangement, the behavior of the fish shoal is predicted, and information of the predicted behavior is provided. Therefore, even an inexperienced user is able to easily find the fish shoal.

In a preferred embodiment of the present invention, the detection result output unit includes a fish kind prediction unit that processes the result of the recognition by the image recognition unit to predict the kind of fish contained in the fish shoal, and the detection result output unit outputs the kind of the fish predicted by the fish kind prediction unit as the detection result. With the above structural arrangement, the kind of the fish contained in the fish shoal is predicted, and information of the predicted fish kind is provided. Therefore, even an inexperienced user is able to easily know the kind of the fish, and is able to easily find the fish shoal containing the known kind of fish.

In a preferred embodiment of the present invention, the fish finder further includes a teacher data input unit that inputs teacher data including information of an actual fish shoal correlated with the result of the recognition by the image recognition unit, and the image recognition unit includes a learning image recognition engine that learns based on the teacher data inputted by the teacher data input unit. With the above structural arrangement, the image recognition engine is able to learn from the inputted teacher data thus improving the accuracy of the recognition. Thus, the fish shoal is able to be found with a higher accuracy.

In a preferred embodiment of the present invention, the teacher data includes data of the kind of fish contained in the actual fish shoal. With the above structural arrangement, the kind of the fish contained in the fish shoal is able to be learned. Thus, the image recognition makes it possible to provide information of the fish kind, and to find a fish shoal containing the specific kind of fish.

In a preferred embodiment of the present invention, the camera is a 360-degree camera. Therefore, the water surface all around the user and the marine vessel, for example, is able to be monitored.

In a preferred embodiment of the present invention, the camera is mounted in or on a mobile communication device. In this case, the camera of the mobile communication device is directed to the water surface to photograph the image, and the recognition process is performed on the image to find the fish shoal.

In a preferred embodiment of the present invention, at least one function of the fish finder is at least partially installed in or on the mobile communication device. Therefore, the fish finder need not be fixed to the marine vessel.

In a preferred embodiment of the present invention, the camera is mounted in or on a drone. Thus, the image of the water surface is able to be photographed from a viewpoint spaced apart from the user and the marine vessel, and the recognition process is able to be performed on the image to find the fish shoal. Therefore, a wider water surface area is able to be explored to find the fish shoal.

In a preferred embodiment of the present invention, at least one function of the fish finder is at least partially installed in or on the drone. With the above structural arrangement, information of the fish shoal detection result is provided by the drone.

In a preferred embodiment of the present invention, the camera is mounted in or on an artificial satellite. Thus, the image of the water surface is able to be photographed from a viewpoint spaced apart from the user and the marine vessel, and the recognition process is able to be performed on the image to find the fish shoal. In addition, the exploration area is wider as compared with the case where the camera is mounted in or on the drone.

In a preferred embodiment of the present invention, the image recognition unit includes an image recognition server provided on a network. With the above structural arrangement, the device to be used by the user does not need to have the function of the image recognition unit. The image recognition server is able to be shared by a plurality of users.

In a preferred embodiment of the present invention, the detection result output unit includes a fish shoal information server provided on the network to process the result of the recognition by the image recognition unit and provide information of the fish shoal. With the above structural arrangement, the device to be used by the user does not need to have the function of the detection result output unit. Further, the fish shoal information server is able to be shared by a plurality of users.

In a preferred embodiment of the present invention, the fish shoal information server computes the fish shoal information based on the results of the image recognition process performed on image data outputted by a plurality of cameras, and provides the computed information. Thus, the fish shoal information is able to be provided with a higher accuracy. Particularly, the accuracy of information such as information of the predicted fish shoal position is increased by using the results of the recognition process performed on image data outputted from a plurality of cameras located at different positions.

In a preferred embodiment of the present invention, an image recognition server is provided in or on the network for use as the image recognition unit of the fish finder.

In a further preferred embodiment of the present invention, a fish shoal information server is provided in or on the network for use as the detection result output unit of the fish finder.

In a preferred embodiment of the present invention, a client terminal device is connectable to the network to transmit the image data to the image recognition server via the network for the image recognition process to be performed on the image data by the image recognition server.

In a preferred embodiment of the present invention, a client terminal device is connectable to the network to receive information provided by the fish shoal information server via the network.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows an exemplary construction of a marine vessel provided with a fish finder according to a preferred embodiment of the present invention.

FIG. 2 is a block diagram for describing the electrical configuration of the fish finder.

FIGS. 3A and 3B illustrate images obtained by photographing a water surface and characteristic images recognized in the photographed images by way of example.

FIG. 4 is a flowchart for describing an exemplary process to be performed by a computer of the fish finder.

FIG. 5 is a flowchart for describing an exemplary process for learning by an image recognition engine.

FIG. 6 is a diagram for describing another preferred embodiment of the present invention.

FIG. 7 is a diagram for describing another preferred embodiment of the present invention.

FIG. 8 is a diagram for describing still another preferred embodiment of the present invention.

FIG. 9 is a diagram for describing yet another preferred embodiment of the present invention.

### DETAILED DESCRIPTION OF THE PREFERRED EMBODIMENTS

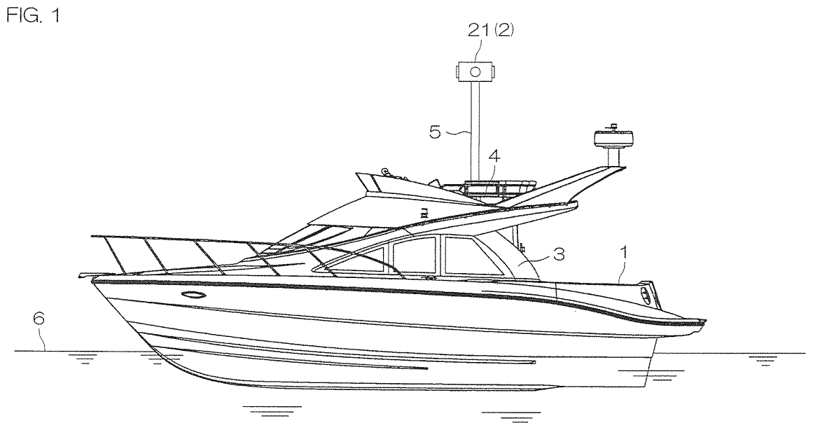

FIG. 1 shows an exemplary construction of a marine vessel provided with a fish finder according to a preferred embodiment of the present invention. The fish finder 2 includes a camera 21 to observe the state of the water surface around the marine vessel 1. The camera 21 is, for example, a 360-degree camera. In the present preferred embodiment, the camera 21 is attached to a pole 5 extending vertically upward from a roof 4 of a cabin 3. The camera 21 has a horizontal view angle of 360 degrees along a horizontal plane around the pole, and a vertical view angle including at least a dip angle range below the horizontal plane. Thus, the camera 21 is able to photograph an image of the water surface 6 in an omnidirectional range around the marine vessel 1.

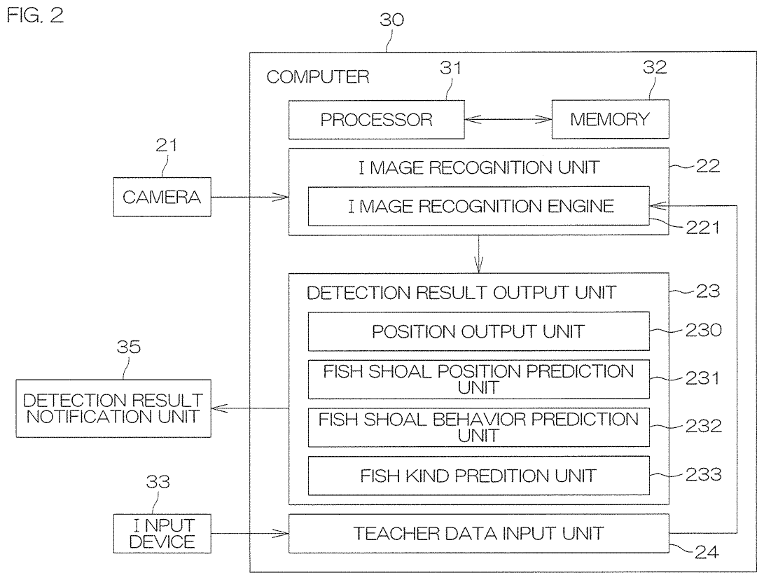

FIG. 2 is a block diagram for describing the electrical configuration of the fish finder. The fish finder 2 includes the camera 21, an image recognition unit 22, a detection result output unit 23, and a detection result notification unit 35. In the present preferred embodiment, the image recognition unit 22 and the detection result output unit 23 are embodied by the function of a computer 30. The computer 30 includes a processor 31 and a memory 32, and executes a program stored in the memory 32 to function as the image recognition unit 22 and the detection result output unit 23. In the present preferred embodiment, the detection result notification unit 35 is, for example, a display device which displays a detection result. Further, a speaker, a buzzer, or other sound emitting devices which provide notification of the detection result by sound are usable as the detection result notification unit 35.

The camera 21 photographs an image around the marine vessel 1, and outputs data indicative of the image (image data). The image data is inputted to the computer 30. The image recognition unit 22 performs an image recognition process on the image data outputted by the camera 21 to recognize a characteristic image implying the presence of a fish shoal. The detection result output unit 23 processes the result of the recognition by the image recognition unit 22, and outputs the detection result. The detection result notification unit 35 notifies the user of the detection result.

The detection result output unit 23 may include a position output unit 230 which outputs the position of the characteristic image as the detection result. The position output unit 230 may output the position of the characteristic image in the image photographed by the camera 21. In this case, for example, the detection result notification unit 35 preferably includes a display device which provides a display output indicating the position of the characteristic image in the image photographed by the camera 21. The position output unit 230 may output positional information indicating the position of a specific object contained in the characteristic image. The positional information may indicate a relative position of the object contained in the characteristic image with respect to the marine vessel 1. In this case, the positional information may contain information of an azimuth angle with respect to the marine vessel 1 and a distance from the marine vessel 1. The positional information may be information indicating absolute coordinates of the object contained in the characteristic image. In this case, the positional information may be information indicating the latitude and the longitude of the object contained in the characteristic image.

The detection result output unit 23 may include a fish shoal position prediction unit 231 which processes the result of the recognition by the image recognition unit 22 to compute a predicted fish shoal position. In this case, the detection result output unit 23 preferably outputs the predicted fish shoal position computed by the fish shoal position prediction unit 231 as the detection result. Then, the detection result notification unit 35 preferably includes a display device which provides a display output indicating the predicted fish shoal position in the image photographed by the camera 21. The fish shoal to be subjected to the prediction of the position is typically a shoal of fish to be fished. Where a shoal of small fish chased by large migratory fish gather at the water surface and such a phenomenon is recognized in the image, for example, the fish to be fished is generally the large migratory fish but not the small-fish shoal. In this case, a peripheral area around the small-fish shoal is the fish shoal position to be predicted for fishing.

The detection result output unit 23 may include a fish shoal behavior prediction unit 232 which processes the result of the recognition by the image recognition unit 22 to compute a predicted fish shoal behavior. In this case, the detection result output unit 23 preferably outputs the predicted fish shoal behavior computed by the fish shoal behavior prediction unit 232 as the detection result. Then, the detection result notification unit 35 preferably outputs the computed predicted behavior as the detection result. The detection result notification unit 35 may display a text or an image indicating the predicted fish shoal behavior on the display device. The fish shoal to be subjected to the prediction of the behavior is typically a shoal of fish to be fished. Where a phenomenon such that a shoal of small fish gather at the water surface is recognized in the image, for example, the behavior of large migratory fish is predicted based on the behavior of the small-fish shoal. Further, the behavior of large migratory fish may be predicted based on the behavior of birds flocking at the small-fish shoal.

The detection result output unit 23 preferably includes a fish kind prediction unit 233 which processes the result of the recognition by the image recognition unit 22 to predict the kind of fish contained in the fish shoal. In this case, the detection result output unit 23 preferably outputs the predicted fish kind as the detection result. The detection result notification unit 35 may display a text or an image indicating the kind of the fish on the display device, or may output a voice reading out the kind of the fish from a speaker. The fish shoal to be subjected to the prediction of the fish kind is typically a shoal of fish to be fished. Where a phenomenon such that a shoal of small fish gather at the water surface is recognized in the image, for example, the kind of large migratory fish chasing the small-fish shoal is predicted.

The image recognition unit 22 may include a learning image recognition engine 221. In this case, the computer 30 may have a function as a teacher data input unit 24. Further, the computer 30 may be connectable to an input device 33 such as a pointing device, a keyboard, or a touch panel provided on the display device.

The teacher data input unit 24 generates teacher data by correlating information inputted from the input device 33 with the result of the recognition by the image recognition unit 22. The image recognition engine 221 improves the accuracy of the image recognition by learning based on the teacher data. The information inputted from the input device 33 may be information indicating the presence of a fish shoal. Thus, a specific image pattern is able to be recognized as a characteristic image implying the possibility of the presence of the fish shoal. The information inputted from the input device 33 may be information indicating the kind of fish. With the above structural arrangement, when a specific characteristic image is recognized, information indicating the kind of a fish shoal correlated with the specific characteristic image is also able to be provided. In this case, the fish kind prediction unit 233 may predict the fish kind by retrieving the fish kind information correlated with the recognized characteristic image from the image recognition unit 22.

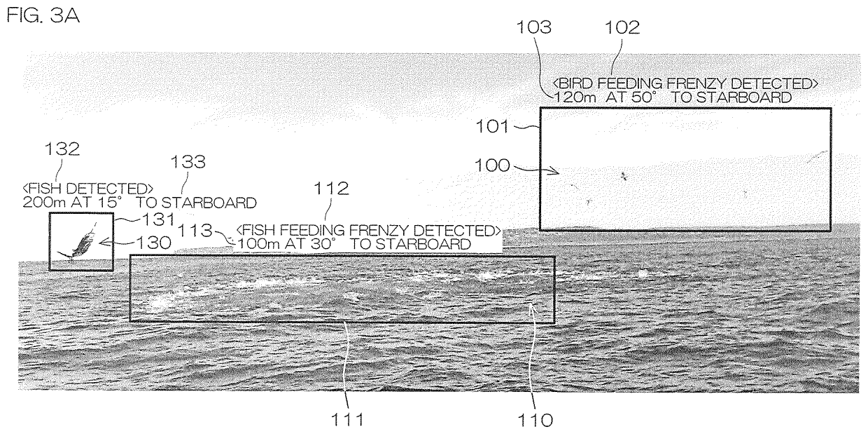

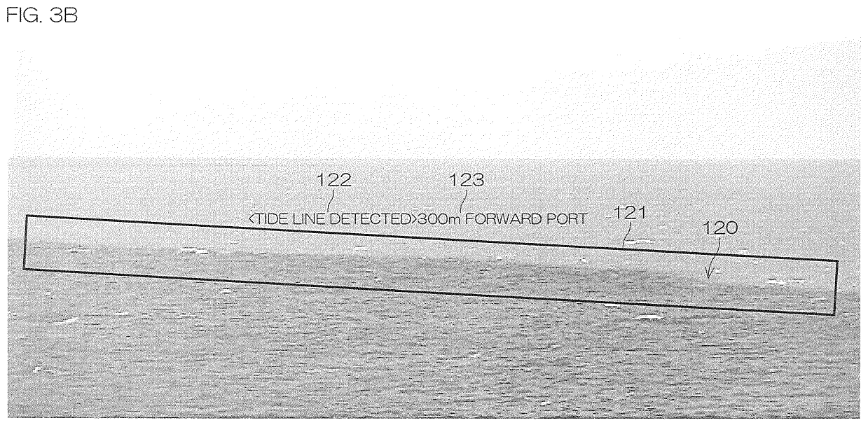

FIG. 3A shows characteristic images and recognition results displayed together with the characteristic images by way of example. In FIG. 3A, an exemplary display image is shown, which includes a bird feeding frenzy image 100, a fish feeding frenzy image 110, and an image 130 of fish flying above the water surface.

The bird feeding frenzy image herein refer to an image of a bird feeding frenzy (bird flock) in which many birds flock to a shoal of small fish at the water surface. The bird feeding frenzy image 100 is recognized as one of the characteristic images, and a region of the recognized bird feeding frenzy image 100 is enclosed with a frame line 101. Thus, the position of the bird feeding frenzy image 100 is indicated in the displayed full image. In the exemplary image shown in FIG. 3A, a text “BIRD FEEDING FRENZY DETECTED” is displayed as a characteristic image type 102, and a text indicating positional information 103 such as the azimuth angle and the distance of the bird feeding frenzy with respect to the marine vessel 1 is displayed. When the bird feeding frenzy image 100 is recognized, at least one of the kind, the number, and the behavior of the birds contained in the bird feeding frenzy image 100 is also recognized in the image. The behavior of the birds to be recognized preferably includes at least one of a behavior of the birds plunging into the water surface and a behavior of the birds looking into the water.

The fish feeding frenzy image refers to an image of a fish feeding frenzy in which a shoal of small fish chased by larger fish splash around water at the water surface. The fish feeding frenzy image 110 is recognized as one of the characteristic images, and a region of the recognized fish feeding frenzy image 110 is enclosed with a frame line 111. Thus, the position of the fish feeding frenzy image 110 is indicated in the displayed full image. In the exemplary image shown in FIG. 3A, a text “FISH FEEDING FRENZY DETECTED” is displayed as a characteristic image type 112, and a text indicating positional information 113 such as the azimuth angle and the distance of the fish feeding frenzy with respect to the marine vessel 1 is displayed.

The image of fish flying above the water surface is an image in which fish jump up above the water surface. For example, small fish (e.g., flying fish) chased by larger fish jump up from the water, or large fish jump up above the water surface. In FIG. 3A, an image 130 of large fish jumping up is shown. The image 130 is recognized as one of the characteristic images, and a region of the recognized image 130 is enclosed with a frame line 131. Thus, the position of the image 130 is indicated in the displayed full image. In the exemplary image shown in FIG. 3A, a text “FISH DETECTED” is displayed as a characteristic image type 132, and a text indicating positional information 133 such as the azimuth angle and the distance of the detected fish with respect to the marine vessel 1 is displayed.

FIG. 3B shows a characteristic image and recognition results displayed together with the characteristic image by way of another example. In FIG. 3B, an exemplary image is shown, which includes a tide line image 120. The tide line image is an image of a tide line. The tide line is a boundary line appearing along an interface between ocean currents or an interface between different sea water temperature zones at the water surface. The tide line image 120 is recognized as one of the characteristic images, and a region of the recognized tide line image 120 is enclosed with a frame line 121. Thus, the position of the tide line image 120 is indicated in the displayed full image. In the exemplary image shown in FIG. 3B, a text “TIDE LINE DETECTED” is displayed as a characteristic image type 122, and a text indicating positional information 123 such as the azimuth angle and the distance of the tide line with respect to the marine vessel 1 is displayed.

Additional examples of the characteristic images implying the presence of the fish shoal include an image of fish swimming in the water, an image of a bird plunging into the water surface, and an image of a bird looking into the water.

The characteristic images may each be a still image (single still image) or a video image (including a plurality of images consecutive along a time axis).

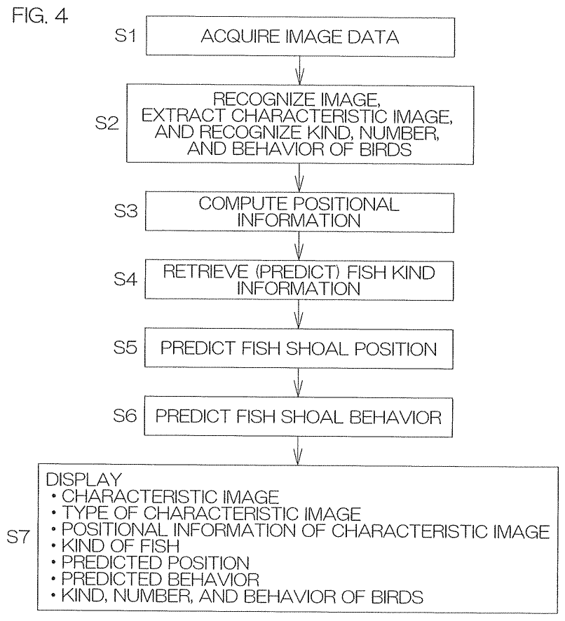

FIG. 4 is a flowchart for describing an exemplary process to be performed by the computer 30. The computer 30 acquires image data outputted by the camera 21 (Step S1), and performs an image recognition process on the acquired image data to extract a characteristic image (Step S2). The computer 30 checks the type of the extracted characteristic image. Examples of the characteristic image type include the bird feeding frenzy image, the fish feeding frenzy image, and the tide line image, which are distinguishable from each other. Where the bird feeding frenzy image is recognized, at least one of the kind, the number, and the behavior of birds contained in the bird feeding frenzy image is preferably further recognized in the image.

Further, the computer 30 computes the positional information of the extracted characteristic image (Step S3). The positional information of the characteristic image includes information of the position of the characteristic image in the photographed image, information of the azimuth angle of the characteristic image with respect to the marine vessel 1, and information of the distance of the characteristic image from the marine vessel 1. Further, the computer 30 retrieves fish kind information correlated with the extracted characteristic image (Step S4). The correlated fish kind information, if found, is extracted. Further, the computer 30 may perform a computation to predict the position of the fish shoal and the behavior of the fish shoal based on the characteristic image (Steps S5 and S6).

The computer 30 causes the detection result notification unit 35 to display an image containing the characteristic image (Step S7). At this time, the computer 30 displays, for example, a frame line indicating the position of the characteristic image in the displayed image, and displays the type of the characteristic image and the information of the position of the characteristic image with respect to the marine vessel. If the computer 30 is able to predict the kind of fish (or retrieve information of the kind of fish), the computer 30 causes the detection result notification unit 35 to also display the fish kind information. Further, the computer 30 causes the detection result notification unit 35 to display the predicted position and the predicted behavior of the fish shoal. Where the bird feeding frenzy image is recognized and the kind, the number, and the behavior of birds are further recognized in the image, such information is also preferably displayed.

Thus, the user is able to acquire information from the detection result notification unit 35, and sail the marine vessel 1 toward the fish shoal based on the acquired information.

In most cases, as described above, fish to be fished are large migratory fish chasing small fish. Therefore, it is preferred that the kind, the position, and the behavior of a shoal of fish to be fished are predicted based on the position and the behavior of a small-fish shoal around the bird feeding frenzy or a small-fish shoal causing the fish feeding frenzy, and the user is notified of the results of the prediction. Thus, the user is able to easily know the position of the shoal of the fish to be fished.

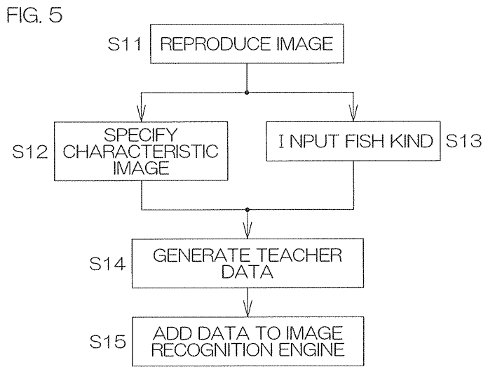

FIG. 5 is a flowchart for describing an exemplary process to be performed for learning by the image recognition engine 221. The computer 30 stores image data of an image photographed by the camera 21 and/or image data of an image displayed by the detection result notification unit 35 in the memory 32. Image data only for a predetermined period may be stored, and old image data may be discarded.

The user operates the input device 33 to put the computer 30 in a learning mode. Then, the user reproduces the image data (Step S11). If the user finds a characteristic image implying the presence of a fish shoal in the reproduced image, the user is able to specify the region of the characteristic image by operating the input device 33 (Step S12). Thus, the computer 30 generates teacher data indicating that the characteristic image is an image sample implying the presence of the fish shoal (Step S14), and adds the teacher data to the image recognition engine 221 (Step S15).

Further, when the user fishes based on the specific characteristic image recognized in the reproduced image and is able to specify the kind of fish to be correlated with the characteristic image, the user inputs the fish kind in correlation with the characteristic image from the input device 33 (Step S13). Then, the computer 30 generates teacher data including the inputted fish kind information correlated with the characteristic image (Step S14), and adds the teacher data to the image recognition engine 221 (Step S15).

The image recognition engine 221 improves the accuracy of the recognition by learning based on the teacher data.

With the above structural arrangement, the accuracy of the recognition is improved according to the input by the user, so that the fish finder 2 is updated to be more convenient.

The predicted position and the predicted behavior of the fish shoal may also be learned in the above-described manner by the image recognition engine 221.

In the present preferred embodiment, as described above, the image of the water surface is photographed by the camera 21, and the image recognition process is performed on the image data outputted by the camera 21 to recognize the characteristic image implying the presence of the fish shoal. Then, the detection result is outputted based on the characteristic image. Thus, the user is able to easily find the fish shoal based on the phenomena observable on the water surface irrespective of the experience of the user.

In the present preferred embodiment, the characteristic image to be recognized includes the image of a fish feeding frenzy, the image of tide line, the image of fish flying above the water surface, and the image of birds. Therefore, even an inexperienced user is able to easily find the fish shoal based on any of the fish feeding frenzy, the tide line, the fish flying above the water surface, and the birds. Where the characteristic image contains the image of fish swimming in the water, even an inexperienced user is able to easily find the fish shoal based on the fish swimming in the water. Where the kind, the number, or the behavior of the birds is also recognized from the bird feeding frenzy image, even an inexperienced user is able to find the fish shoal based on such information.

In the present preferred embodiment, the detection result notification unit 35 includes a display device, and the position of the characteristic image is indicated by the frame line in the image photographed by the camera 21. Thus, the user is able to easily detect the position of the characteristic image and, therefore, is able to easily find the fish shoal. In addition, the positional information is also displayed in the image, making it easier to find the fish shoal.

Where the kind, the predicted position, or the predicted behavior of the fish shoal to be fished is provided by the detection result notification unit 35, even an inexperienced user is able to more easily find the fish shoal.

Where the camera 21 is the 360-degree camera, the water surface all around the user and the marine vessel 1 is monitored making it easier to find the fish shoal.

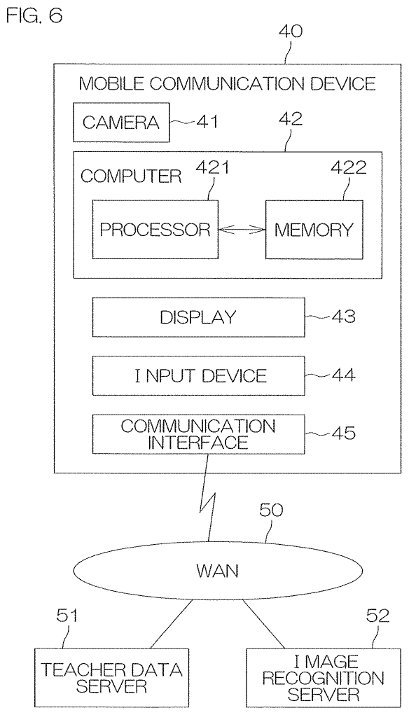

FIG. 6 is a diagram for describing another preferred embodiment of the present invention. In the present preferred embodiment, the function of the fish finder is installed in a mobile communication device 40, typically, in a smartphone or a cellular phone, while the fish finder is mounted on or in the marine vessel in the preferred embodiment described above. The mobile communication device 40 includes a camera 41, a computer 42, a display device 43, an input device 44, and a communication interface 45. The camera 41 is typically a camera having a wide angle lens. Of course, a 360-degree camera may be externally fit to the mobile communication device 40.

The computer 42 includes a processor 421 and a memory 422. The functions of the camera 41 and the computer 42 are substantially the same as in the first preferred embodiment described above. A program for the function of the computer 42 is provided, for example, as an application program to be executed on an operating system, and stored in the memory 422 of the computer 42. The processor 421 executes the program stored in the memory 422, such that the computer 42 provides the same functions as the image recognition unit 22, the detection result output unit 23, and the teacher data input unit 24 provided in the first preferred embodiment described above.

The display device 43 has the same function as the detection result notification unit 35 provided in the first preferred embodiment described above. The input device 44 is typically a touch panel or a keyboard, and corresponds to the input device 33 provided in the first preferred embodiment described above. With the above structural arrangement, the mobile communication device 40 provides the same function as the fish finder 2 provided in the first preferred embodiment.

The communication interface 45 mediates wireless communication between the mobile communication device 40 and a wide area network (WAN) 50. The computer 42 is able to update an image recognition engine via the communication interface 45, and acquire learning teacher data for the image recognition engine from a teacher data server 51 provided on the wide area network 50. Further, the computer 42 is able to upload teacher data to the teacher data server 51 via the communication interface 45.

In an environment in which connection between the mobile communication device 40 and the wide area network 50 is able to be maintained, the computer 42 may use an image recognition server 52 connected to the wide area network 50. That is, the computer 42 transmits image data outputted by the camera 41 to the image recognition server 52. The image recognition server 52 receives the image data, and performs the recognition process on the received image data to extract a characteristic image. Data of the extracted characteristic image is transmitted to the mobile communication device 40. The computer 42 receives the transmitted data via the communication interface 45, and displays a recognition result on the display device 43. Thus, the function of the image recognition unit is partially or entirely provided outside the mobile communication device 40.

With the above structural arrangement, a fish shoal is able to be found by directing the camera 41 of the mobile communication device 40 to the water surface, photographing an image of the water surface, and performing the recognition process on the image of the water surface. Since the function of the fish finder is installed in the mobile communication device 40, the fish finder need not be fixed to the marine vessel.

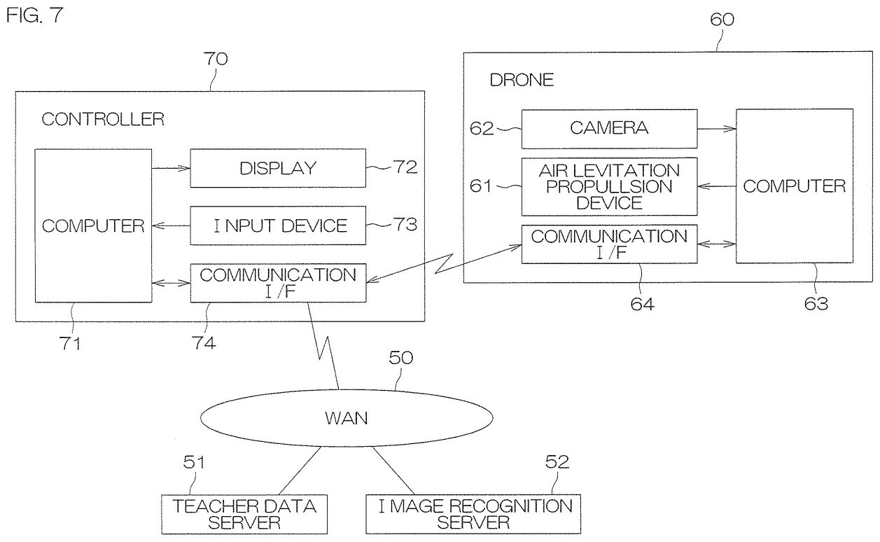

FIG. 7 is a diagram for describing another preferred embodiment of the present invention. In the present preferred embodiment, the fish finder includes a drone 60 and a controller 70.

The drone 60 includes an air levitation propulsion device 61, a camera 62, a computer 63, and a communication interface (I/F) 64. The air levitation propulsion device 61 typically includes a plurality of propellers. The camera 62 is typically a camera including a wide range lens. Of course, the camera 62 may be a 360-degree camera.

The computer 63 communicates with the controller 70 via the communication interface 64 (typically through wireless communication). Thus, the computer 63 receives a flight command signal from the controller 70, and transmits information to the controller 70. The flight command signal is a signal commanding the traveling direction, the traveling speed, and the like of the drone 60. The computer 63 controls the air levitation propulsion device 61 based on the flight command signal to control the movement (flight) of the drone 60. The information to be transmitted to the controller 70 includes image data of an image photographed by the camera 62.

The controller 70 may be a smartphone or other mobile information device (mobile communication device), or may be a stationary device fixed to the marine vessel. The controller 70 includes a computer 71, a display device 72, an input device 73, and a communication interface (I/F) 74.

The computer 71 communicates with the drone 60 via the communication interface 74 (typically through wireless communication). Thus, the computer 71 transmits a flight command signal to the drone 60, and receives information from the drone 60. The information to be received includes image data outputted by the camera 62 provided in the drone 60. The computer 71 displays the image photographed by the camera 62 on the display device 72 based on the image data.

The input device 73 may be a touch panel, a joystick or the like. The computer 71 transmits a flight command signal to the drone 60 according to the operation of the input device 73 by the user or according to a predetermined program. Thus, the flight of the drone 60 is remotely controlled.

In a specific example, the computer 71 provided in the controller 70 has the same functions as the image recognition unit 22, the detection result output unit 23, and the teacher data input unit 24 provided in the first preferred embodiment described above. In this case, the computer 63 of the drone 60 transmits the image data to the controller 70 from the communication interface 64.

In another specific example, the computer 63 of the drone 60 has the same functions as the image recognition unit 22, the detection result output unit 23, and the teacher data input unit 24 provided in the first preferred embodiment described above. In this case, the computer 63 of the drone 60 transmits not only the image data but also the result of the recognition of a characteristic image and relevant information to the controller 70 from the communication interface 64. The relevant information includes the positional information of the characteristic image, and information of the predicted position and the predicted behavior of a fish shoal to be fished.

Like the mobile communication device 40 in the second preferred embodiment, the controller 70 may be connected to a wide area network 50 such as the internet. In this case, the communication interface 74 mediates wireless communication between the wide area network 50 and the controller 70. The computer 71 is able to update an image recognition engine via the communication interface 74, and acquire learning teacher data for the image recognition engine from a teacher data server 51 provided on the wide area network 50. Further, the computer 71 uploads teacher data to the teacher data server 51 via the communication interface 74.

In an environment in which connection between the controller 70 and the wide area network 50 is able to be maintained, the computer 71 may use an image recognition server 52 provided on the wide area network 50. That is, the computer 71 transmits the image data acquired from the drone 60 to the image recognition server 52. The image recognition server 52 receives the image data, and performs the recognition process on the received image data to extract a characteristic image. Data of the characteristic image is transmitted to the controller 70. The computer 71 receives the data via the communication interface 74, and displays the result of the recognition on the display device 72. Thus, the function of the image recognition unit is partially or entirely provided outside the controller 70 and the drone 60.

In the present preferred embodiment, the fish shoal is found by photographing an image of the water surface from a viewpoint spaced apart from the user and the marine vessel with the use of the camera 62 of the drone 60, and performing the recognition process on the photographed image. Thus, a wider water surface area is able to be explored to find the fish shoal.

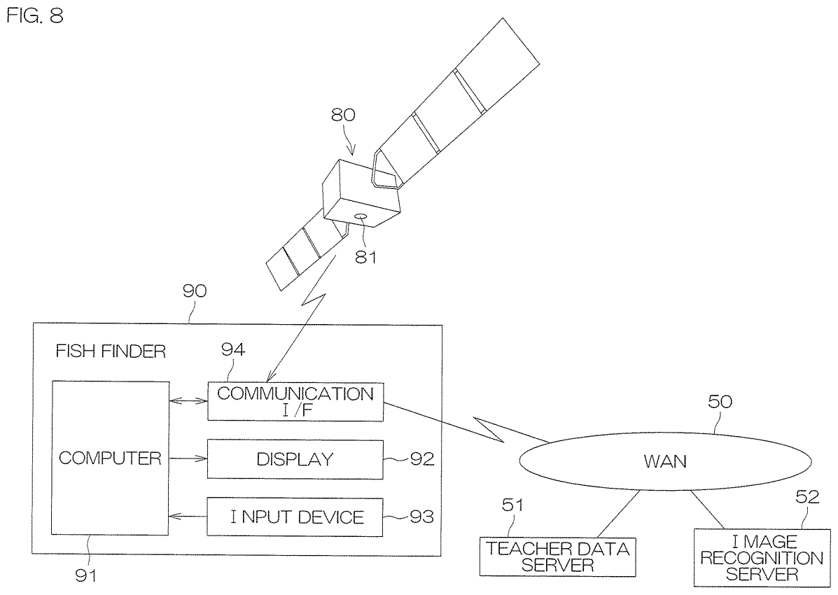

FIG. 8 is a diagram for describing still another preferred embodiment of the present invention. In the present preferred embodiment, image data of an image photographed by a camera 81 provided by an artificial satellite 80, i.e., a satellite image, is utilized. The camera 81 photographs an image of the earth surface (including lake surfaces and ocean surfaces). In the present preferred embodiment, a fish finder 90 communicates with the artificial satellite 80. The fish finder 90 may be a smartphone or other mobile information device, or may be a stationary processing device fixed to the marine vessel.

The fish finder 90 includes a computer 91, a display device 92, an input device 93, and a communication interface 94. The computer 91 communicates with the artificial satellite 80 via the communication interface 94 (typically through wireless communication). Thus, the computer 91 receives information from the artificial satellite 80. The information to be received includes image data of the satellite image outputted by the camera 81 mounted in or on the artificial satellite 80. Based on the image data, the computer 91 displays the satellite image on the display device 92. The input device 93 may be a touch panel, a joystick or the like.

The computer 91 has the same functions as the image recognition unit 22, the detection result output unit 23, and the teacher data input unit 24 provided in the first preferred embodiment described above.

Like the mobile communication device 40 in the second preferred embodiment, the fish finder 90 may be connected to a wide area network 50 such as the internet. In this case, the communication interface 94 mediates wireless communication between the wide area network 50 and the computer 91. The computer 91 updates an image recognition engine via the communication interface 94, and acquires learning teacher data of the image recognition engine from a teacher data server 51 provided on the wide area network 50. The computer 91 uploads teacher data to the teacher data server 51 via the communication interface 94.

In an environment in which connection between the fish finder 90 and the wide area network 50 is able to be maintained, the computer 91 may utilize an image recognition server 52 provided on the wide area network 50. That is, the computer 91 transmits the image data of the satellite image to the image recognition server 52. The image recognition server 52 receives the image data, and performs the recognition process on the received image data to extract a characteristic image. Data of the extracted characteristic image is transmitted to the fish finder 90. The computer 91 receives the data via the communication interface 94, and displays a recognition result on the display device 92. Thus, the function of the image recognition unit is partially or entirely provided outside the fish finder 90.

In the present preferred embodiment, a fish shoal is found by photographing an image of the water surface from a viewpoint spaced apart from the user and the marine vessel with the use of the camera 81 of the artificial satellite 80, and performing the recognition process on the photographed image. In addition, a wider area is able to be explored as compared with the case utilizing the camera mounted in or on the drone, such that the fish shoal finding operation is extensively performed.

The artificial satellite 80 and the wide area network 50 may be connected to each other for communication, and the image data of the satellite image outputted by the camera 81 may be provided on the wide area network 50. In this case, the fish finder 90 may acquire the image data of the satellite image from the wide area network 50.

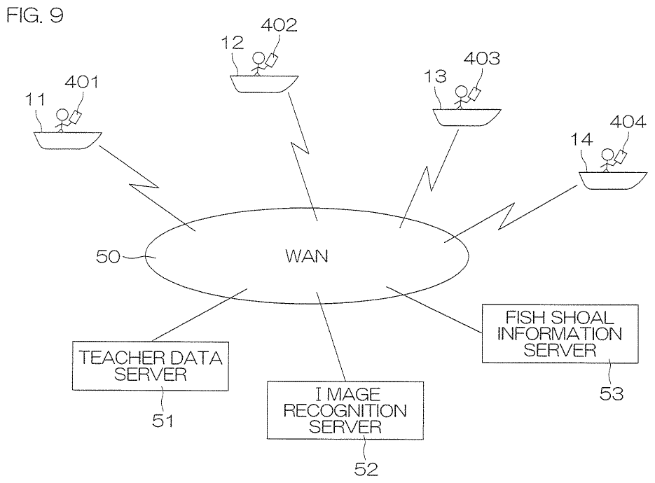

FIG. 9 is a diagram for describing yet another preferred embodiment of the present invention. In the present preferred embodiment, an image recognition server 52 and a fish shoal information server 53 are provided on a wide area network 50. A plurality of client terminal devices 401, 402, 403, 404, . . . are connected to the wide area network 50 for communication with the wide area network 50. The client terminal devices 401, 402, 403, 404, . . . are typically used on different marine vessels 11, 12, 13, 14, . . . . The client terminal devices 401, 402, 403, 404, . . . may each be a mobile communication device (see FIG. 6) which can be held by the user, or a stationary device fixed to the marine vessel (see FIG. 7). In the following description, the client terminal devices 401, 402, 403, 404, . . . are each a mobile communication device 40 shown in FIG. 6 by way of example. As required, reference will be made to FIG. 6.

An application program for uploading image data of an image photographed by the camera 41 and acquiring information of a fish shoal through communication with the image recognition server 52 and the fish shoal information server 53 is incorporated in the client terminal device 401, 402, 403, 404, . . . (in the form of the mobile communication device 40 in FIG. 6). By executing the application program, the user transmits image data obtained by photographing the water surface around the marine vessel by the camera 41 to the image recognition server 52, and acquires predicted fish shoal information from the fish shoal information server 53. When the client terminal device 401, 402, 403, 404, . . . transmits the image data to the image recognition server 52, the client terminal device 401, 402, 403, 404, . . . preferably also transmits positional information (coordinate data and the like) and information indicating the photographing direction of the camera 41.

The image recognition server 52 receives the image data transmitted from the client terminal device 401, 402, 403, 404, . . . via the wide area network 50, and performs the image recognition process on the received image data to extract a characteristic image. The image recognition server 52 transmits information of the characteristic image to the fish shoal information server 53 via the wide area network 50.

The fish shoal information server 53 predicts fish shoal information based on the information received from the image recognition server 52. The fish shoal information server 53 performs the same process as the above-described detection result output unit 23 to predict the fish shoal information. The information to be predicted preferably includes at least one of the kind of fish, the position of the fish shoal, and the behavior of the fish shoal. The predicted information is transmitted to the client terminal device 401, 402, 403, 404, . . . via the wide area network 50. The fish shoal information server 53 may predict the fish shoal information based on information obtained through the image recognition of the image data transmitted from one of the client terminal devices 401, 402, 403, 404, . . . . Further, the fish shoal information server 53 may predict the fish shoal information based on information obtained through the image recognition of the image data transmitted from the plurality of client terminal devices 401, 402, 403, 404, . . . .

The fish shoal information server 53 is able to predict more accurate information by combining the information obtained through the image recognition of the image data transmitted from the plurality of client terminal devices 401, 402, 403, 404, . . . . Where the moving direction of a bird is predicted through the image recognition of image data from one of the client terminal devices 401, 402, 403, 404, . . . and the moving direction of another bird is predicted through the image recognition of image data from another of the client terminal devices 401, 402, 403, 404, . . . , for example, the fish shoal information server 53 is able to predict that a fish shoal would be present at a position at which the bird moving directions intersect each other. Thus, the position of the fish shoal and the like is able to be accurately predicted based on the result of analysis of images from the plurality of client terminal devices 401, 402, 403, 404, . . . . The bird moving directions may be determined through the image recognition process by the image recognition server 52. Alternatively, the fish shoal information server 53 may determine the bird moving directions by processing the result of the image recognition.

The client terminal device 401, 402, 403, 404, . . . receive the information from the fish shoal information server 53, and provide the received information to the user (typically displays the received information on the display device). For example, the client terminal device 401, 402, 403, 404, . . . may display the fish shoal position on a map.

As in the preferred embodiments described above, a teacher data server 51 may be provided on the wide area network 50. The client terminal device 401, 402, 403, 404, . . . may upload teacher data to the teacher data server 51. In this case, the image recognition server 52 learns with the use of teacher data accumulated in the teacher data server 51 to improve the image recognition function.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A fish finder comprising:
a computer programmed to define and function as:
an image recognition unit to perform an image recognition process on image data outputted by a camera to recognize a characteristic image implying presence of a fish shoal; and
a detection result output unit to process a result of the recognition by the image recognition unit and output a detection result.

2. The fish finder according to claim 1, wherein the characteristic image includes at least one of an image containing a fish feeding frenzy, an image containing a tide line, an image of fish flying above a water surface, and an image of a bird.

3. The fish finder according to claim 1, wherein the characteristic image includes an image of fish swimming in water.

4. The fish finder according to claim 1, wherein
the characteristic image includes an image of birds; and
the image recognition unit outputs at least one of a kind of the birds, a number of the birds, and a behavior of the birds as the recognition result based on the image of the birds.

5. The fish finder according to claim 4, wherein the behavior of the birds includes at least one of a behavior of the birds plunging into a water surface and a behavior of the birds looking into water.

6. The fish finder according to claim 1, wherein the detection result output unit is configured or programmed to output a position of the characteristic image in an image photographed by the camera as the detection result.

7. The fish finder according to claim 1, wherein the detection result output unit includes a fish shoal position prediction unit to process the result of the recognition by the image recognition unit to compute a predicted fish shoal position, and the detection result output unit is configured or programmed to output the predicted fish shoal position computed by the fish shoal position prediction unit as the detection result.

8. The fish finder according to claim 1, wherein the detection result output unit includes a behavior prediction unit to process the result of the recognition by the image recognition unit to compute a predicted fish shoal behavior, and the detection result output unit is configured or programmed to output the predicted fish shoal behavior computed by the behavior prediction unit as the detection result.

9. The fish finder according to claim 1, wherein the detection result output unit includes a fish kind prediction unit to process the result of the recognition by the image recognition unit to predict a kind of fish contained in the fish shoal, and the detection result output unit is configured or programmed to output the kind of the fish predicted by the fish kind prediction unit as the detection result.

10. The fish finder according to claim 1, wherein the computer is programmed to define and function as:
a teacher data input unit to input teacher data including information of an actual fish shoal correlated with the result of the recognition by the image recognition unit; and
the image recognition unit includes a learning image recognition engine to learn based on the teacher data inputted by the teacher data input unit.

11. The fish finder according to claim 10, wherein the teacher data includes data of a kind of fish contained in the actual fish shoal.

12. The fish finder according to claim 1, wherein the camera is a 360-degree camera.

13. The fish finder according to claim 1, wherein the camera is mounted in or on a mobile communication device.

14. The fish finder according to claim 1, wherein the computer is at least partially installed in or on a mobile communication device.

15. The fish finder according to claim 1, wherein the camera is mounted in or on a drone.

16. The fish finder according to claim 1, wherein the computer is at least partially installed in or on a drone.

17. The fish finder according to claim 1, wherein the camera is mounted in or on an artificial satellite.

18. The fish finder according to claim 1, wherein the image recognition unit includes an image recognition server provided on or in a network.

19. The fish finder according to claim 1, wherein the detection result output unit includes a fish shoal information server provided on or in a network to process the result of the recognition by the image recognition unit to provide information of the fish shoal.

20. The fish finder according to claim 19, wherein the fish shoal information server is configured or programmed to compute the fish shoal information based on results of the image recognition process performed on image data outputted by a plurality of cameras.

21. An image recognition server provided on a network, the image recognition server comprising:
the image recognition unit of the fish finder according to claim 1.

22. A fish shoal information server provided on a network, the fish shoal information server comprising:
the detection result output unit of the fish finder according to claim 1.

23. A client terminal device connectable to a network to transmit image data to the image recognition server according to claim 21 via the network for the image recognition of the image data by the image recognition server.

24. A client terminal device connectable to a network to receive information provided by the fish shoal information server according to claim 22 via the network.
